(19) United States
(12) Patent Application Publication
(10) Pub. No.: US 2012/0083958 A1
(43) Pub. Date: Apr. 5, 2012

(54) SYSTEM FOR SIMULATING MANUAL TRANSMISSION OPERATION IN A VEHICLE

(75) Inventor: CLAUDIO R. BALLARD, FORT LAUDERDALE, FL (US)

(73) Assignee: POTENS IP HOLDINGS LLC, FORT LAUDERDALE, FL (US)

(21) Appl. No.: 13/249,033

(22) Filed: Sep. 29, 2011

Related U.S. Application Data
(60) Provisional application No. 61/388,494, filed on Sep. 30, 2010.

(51) Int. Cl. G06F 17/00; B60W 20/00; B60W 10/10; B60W 10/06; B60W 10/08

(52) U.S. Cl. 701/22; 701/56; 903/945

(57) ABSTRACT

An embodiment of a method for simulating manual transmission operation in a vehicle having an automatic transmission includes receiving a selection of a transmission model profile which includes a simulated manual transmission model. The method further includes receiving a gear position user input signal indicative of a position of a user gear selection of the vehicle, receiving a throttle position user input signal indicative of a position of user throttle control of the vehicle, and receiving a clutch position user input signal indicative of a position of a user clutch control of the vehicle. The method still further includes determining a simulated manual transmission response using the selected transmission model profile and at least one of the gear position user input signal, the throttle position user input signal, and the clutch position user input signal, and outputting at least one vehicle control signal corresponding to the simulated transmission response.

### CROSS-REFERENCE TO RELATED APPLICATIONS

This application claims benefit of U.S. Provisional Application Ser. No. 61/388,494, filed on Sep. 30, 2010.

### TECHNICAL FIELD

The following disclosure relates to control systems and user/control system interfaces for vehicles. Specifically, the disclosure relates to control systems and user/control system interfaces for vehicles, which systems and interfaces simulate the operational characteristics of a vehicle having a conventional manually-operated transmission.

### BACKGROUND

The transmission assembly of a typical motor vehicle includes a transmission unit and a torque interrupter device. The transmission unit allows the input-to-output gear ratio to be selectively changed between a plurality of different gear ratios as the vehicle's operating conditions change, thereby allowing the engine to continually operate in a preferred range of RPM and/or torque, e.g., to optimize (increase) power or to optimize (reduce) fuel consumption. The torque interrupter device allows the transfer of torque between the engine and transmission unit to be selectively interrupted, e.g., while the vehicle is stopped and while changing the gear-ratio of the transmission unit. Such vehicle transmission assemblies are commonly categorized as being either “manual transmissions” or “automatic transmissions” based on the type of control interface provided for the user (i.e., driver) to control the operation of the transmission unit and torque interrupter device.

In a manual transmission (also known as a manual gearbox, standard transmission or, informally, as a “manual,” “stick shift,” “straight shift” or “straight drive”), the user interface for the transmission assembly allows the driver to selectively activate the torque interrupter device across the full spectrum of engagement, i.e., from fully disengaged (0% torque transfer), through partially engaged or “slipping” (1%-99% torque transfer) to fully engaged (100% torque transfer), and vice-versa. Further, the driver can selectively control rate of application of the torque interrupter device (i.e., the rate of change of torque transfer percentage) in real time, and can maintain a slipping state (i.e., partial torque transfer) for as long as desired. Still further, the driver can selectively change the gear ratio of the transmission unit to select any of the available gear ratios, regardless of the current gear ratio. In a manual transmission, the torque interrupter device is commonly known as the “clutch,” and the interface for the clutch is typically a foot-activated pedal or (e.g., in motorcycles) a hand-operated lever. The interface for the transmission unit is commonly known as the “gear selector” or “gear shift,” and the interface for the gear selector is typically a hand-operated lever or (e.g., in motorcycles) a foot-operated lever. In automobiles, the gear selector interface may be configured in an “H” pattern having four forward gear ratios, or “extended H” configurations having five, six or more forward gear ratios.

In a manual transmission, changing the gear ratio of the transmission unit to accommodate changing conditions is left to the driver. Many persons, especially driving enthusiasts, believe that a manual transmission provides the most desirable control interface between the driver and the transmission assembly of the vehicle.

In an automatic transmission, the user interface for the transmission assembly typically does not allow the driver to directly control the percentage of torque transfer provided by the torque interrupter device, other than in some cases allowing the driver to selectively activate the torque interrupter device only in fully disengaged (0% torque transfer) or fully engaged (100% torque transfer) mode. Further, the driver typically cannot control rate of change of torque transfer in the torque interrupter device in real time, nor maintain a “slipping” state for an indefinite period. Still further, the interface for the transmission unit typically requires that the driver change gear ratios sequentially. For example, if the transmission unit is currently in second gear, then the next selected gear must be first gear (one gear lower) or third gear (one gear higher). In an automatic transmission, the torque interrupter device commonly comprises a fluid torque converter, and there may be no user interface for the torque converter (e.g., other than the gear selector). The interface for the transmission unit is commonly known as the “gear selector” or “gear shift,” and is and the interface for the gear selector is typically a hand-operated lever. In an automatic transmission, changing the gear ratio of the transmission unit to accommodate changing conditions may be handled by either an automatic controller or by the driver.

Electric vehicles, hybrid gas/electric vehicles and other unconventional vehicles are currently being produced with sophisticated drive trains that include automatic transmissions. As described above, such automatic transmissions do not provide the same user experience as manual transmissions. However, the demand for manual transmissions in electric vehicles, hybrids and even in some models of conventional gas-powered vehicles may be insufficient to warrant the development of actual manual transmissions versions of the vehicle. In other cases, e.g., hybrid gas/electric vehicles, the complexity of the hybrid drive train may not readily accommodate a manual transmission. A need therefore exists, for a system for simulating manual transmission operation in a vehicle having an automatic transmission.

### SUMMARY

An embodiment of a method for simulating manual transmission operation in a vehicle having an automatic transmission includes receiving a selection of a transmission model profile which includes a simulated manual transmission model. The method further includes receiving a gear position user input signal indicative of a position of a user gear selection of the vehicle, receiving a throttle position user input signal indicative of a position of user throttle control of the vehicle, and receiving a clutch position user input signal indicative of a position of a user clutch control of the vehicle. The method still further includes determining a simulated manual transmission response using the selected transmission model profile and at least one of the gear position user input signal, the throttle position user input signal, and the clutch position user input signal, and outputting at least one vehicle control signal corresponding to the simulated transmission response.

An embodiment of an apparatus for simulating manual transmission operation in a vehicle having an automatic transmission includes at least one memory and a control unit in communication with the at least one memory. The at least one memory is configured to store at least one transmission model profile wherein the at least one transmission model profile including a simulated manual transmission model. The control unit includes a first input configured to receive a selection of a selected transmission model profile of the at least one transmission model profiles, a second input configured to receive a gear position user input signal indicative of a position of a user gear selection of the vehicle, a third input configured to receive a throttle position user input signal indicative of a position of user throttle control of the vehicle, and a fourth input configured to receive a clutch position user input signal indicative of a position of a user clutch control of the vehicle. The control unit is configured to determine a simulated manual transmission response using the selected transmission model profile and at least one of the gear position user input signal, the throttle position user input signal, and the clutch position user input signal, and output at least one vehicle control signal corresponding to the simulated manual transmission response.

An embodiment of a method for performing a transaction for simulating manual transmission operation in a vehicle having an automatic transmission includes accessing a server, receiving a list of at least one transmission model profile from the server wherein the at least one transmission model profile includes a simulated manual transmission model, and displaying the list of at least one transmission model profiles. The method further includes receiving a selection of a selected transmission model profile from the at least one transmission model profiles, transacting a purchase of the selected transmission model profile, and downloading the selected transmission model profile to the vehicle. The method still further includes storing the selected transmission model profile in at least one memory.

In another embodiment, a method for controlling the acceleration and speed of a vehicle so as to produce user sensations simulating the experience of a vehicle having a user-selectable, one of a plurality of manually-controlled transmissions comprises the following steps: providing a system including a controller having an electronic memory and a gear selector movable between a plurality of unique positions; loading one of a plurality of different transmission profiles into the electronic memory of the controller. Each transmission profile includes a plurality of simulated gear ratios ranging from a lowest simulated gear ratio to a highest simulated gear ratio, a gear selector table correlating each of the plurality of simulated gear ratios with a unique position of the gear selector. Each of the simulated gear ratios including a maximum speed value and a maximum acceleration value. The lowest simulated gear ratio has a lowest maximum speed value, and the corresponding maximum speed value for each simulated gear ratio increases for successively higher simulated gear ratios. The lowest simulated gear ratio has a highest maximum acceleration value, and the corresponding maximum acceleration value for each simulated gear ratio decreases for successively higher simulated gear ratios. The method further includes the steps of: providing a gear selector position signal to the controller that is indicative of a current position of the gear selector selected from the unique positions; using the gear selector position signal received by the controller and the gear selector table to determine a current simulated gear ratio corresponding to the current position of the gear selector; using the current simulated gear ratio to determine a current maximum speed value and a current maximum acceleration value corresponding to the current simulated gear ratio; controlling, by the controller, the torque output between a motor and a drive wheel of the vehicle to limit the acceleration of the vehicle to the current maximum acceleration value; and controlling, by the controller, the torque output between the motor and the drive wheel of the vehicle to limit the speed of the vehicle to the current maximum speed value.

In another embodiment, the method further comprises the steps of: providing a clutch pedal movable through a first range of motion, wherein each transmission profile further includes a clutch profile, the clutch profile defining a relation between a simulated clutch pedal position and a torque output modifier, the torque output modifier representing a percentage to which the torque output between the motor and the drive wheel is changed in relation to the simulated clutch pedal position; providing a clutch position signal to the controller that is indicative of a current position of the clutch pedal within the first range of motion; using the current position of the clutch pedal assembly to determine a current torque output modifier; and modifying, by the controller, the torque output between the motor and the drive wheel of the vehicle in accordance with the current torque output modifier.

In another embodiment, the method further comprises the steps of: providing a throttle pedal movable through a second range of motion; providing a throttle pedal position signal to the controller that is indicative of a current position of the throttle pedal within the second range of motion; and modifying, by the controller, the torque output between the motor and the drive wheel in accordance with the current position of the throttle pedal.

In another embodiment, the method further comprises the step of receiving a selection of the one of the plurality of different transmission profiles.

In another embodiment, the method further comprises the step of configuring the gear selector in accordance with the selected transmission profile.

In another embodiment, the method further comprises the step of deploying the gear selector in response to the selection of the transmission profile.

In another embodiment, the method further comprises the step of deploying a clutch pedal in response to the selection of the transmission profile.

In another embodiment, the method further comprises the steps of: providing a sensory control module; and outputting at least one commanded sensory output signal from the sensory control module in accordance with the selected transmission profile.

In another embodiment, the at least one commanded sensory output signal of the method includes at least one of an exterior audio signal, interior audio signal, and a vibration signal.

In another embodiment, the method further comprises the step of displaying a shift pattern corresponding to the selected transmission profile.

In another embodiment, the vehicle is a hybrid vehicle having a partially internal combustion and partially electric drive system.

In another embodiment, the vehicle has an electric drive system.

In another embodiment, the vehicle has an internal combustion motor with an automatic transmission.

In another embodiment, a reconfigurable transmission control system for a vehicle configured to produce user sensations simulating the experience of a vehicle having a user-selectable one of a plurality of manually-controlled transmissions comprises: at least one memory, the at least one memory configured to store at least one of a plurality of different transmission profiles; a controller in communication with the at least one memory; and a transmission control interface in communication with the controller, the transmission control interface adapted to be configured in accordance with a selected one of the plurality of different transmission profiles.

In another embodiment, the transmission control interface is a gear selector having a gate shift pattern that is reconfigurable in accordance with the selected one of the plurality of different transmission profiles.

In another embodiment, the transmission control interface is a clutch pedal that is reconfigurable in accordance with the selected one of the plurality of different transmission profiles.

In another embodiment, the reconfigurable transmission control system further includes a force feedback device coupled to the transmission control interface, the force feedback device configured to provide force feedback to the transmission control interface in accordance with the selected one of the plurality of different transmission profiles.

In another embodiment, the transmission control interface is retractable such that it moves between a refracted configuration which is not accessible by a user and a deployed configuration that is accessible by a user.

In another embodiment, the reconfigurable transmission control system further comprises a display configured to display a shift pattern corresponding to the selected one of the plurality of different transmission profiles.

In another embodiment, the reconfigurable transmission control system further comprises a sensory control module configured to output at least one commanded sensory output signal in accordance with the selected transmission model profile.

In another embodiment, the at least one commanded sensory output signal of the control system includes at least one of an exterior audio signal, interior audio signal, and a vibration signal.

### BRIEF DESCRIPTION OF THE DRAWINGS

For a more complete understanding, reference is now made to the following description taken in conjunction with the accompanying Drawings in which:

FIG. 1 illustrates an embodiment of a system for simulating manual transmission operation in a vehicle having an automatic transmission;

FIG. 2 illustrates an embodiment of a process for simulating manual transmission operation in a vehicle having an automatic transmission FIG. 2;

FIG. 3 illustrates an embodiment of a procedure for purchase and activation of a transmission model profile;

FIG. 4A illustrates an embodiment of a dashboard configuration of a vehicle in which the clutch pedal assembly is in a refracted position;

FIG. 4B illustrates an embodiment the dashboard configuration in which the clutch pedal deployment mechanism has extended the clutch pedal assembly into the deployed position;

FIG. 4C illustrates another embodiment of a dashboard configuration having a gear shift portion with a selectively retractable gear shifter, which is shown in the retracted position;

FIG. 4D illustrates the dashboard configuration of FIG. 4C in which the gear shifter is shown in a deployed position;

FIGS. 5A-5C illustrate embodiments of a shift gate of the gear selector assembly;

FIGS. 6A-6C illustrate a shift gate configured to display shift patterns in accordance with various selected transmission model profiles, in particular, FIG. 6A shows the shift gate with a three-speed shift pattern; FIG. 6B shows the shift gate with a four-speed shift pattern; and FIG. 6C shows the shift gate with a six-speed shift pattern;

FIGS. 7A and 7B illustrate embodiments of throttle position vs. supplied engine torque curves for use in calculating a simulated manual transmission response;

FIGS. 8A and 8B illustrate embodiments of gear selector position vs. simulated gear ratio lookup tables for use in calculating a simulated manual transmission response;

FIG. 9 illustrates an embodiment of a process for determining a simulated manual transmission response using a selected transmission model profile and user input signals; and

FIG. 10 illustrates another embodiment of a system for simulating a manual transmission.

### DETAILED DESCRIPTION

Various embodiments provide for a system, method and apparatus for simulating manual transmission operation in a vehicle having an automatic transmission. Although automatic transmissions have simplified operation of motor vehicles, many drivers miss the sensory experience, tactile response, and clutch manipulation experience of driving a vehicle having a manual transmission. For example, many drivers desire the ability to apply a variable amount of force to a clutch pedal in order to control the degree of engagement of the clutch of the manual transmission during the shifting operation. In addition, many drivers experience satisfaction in successful operation of a manual transmission in order to avoid jerkiness, lugging, or stalling of the vehicle during the shifting operation. Various embodiments of the invention may be used in vehicle having electric motors, combustion engines, hybrids, or any other type of motor or engine.

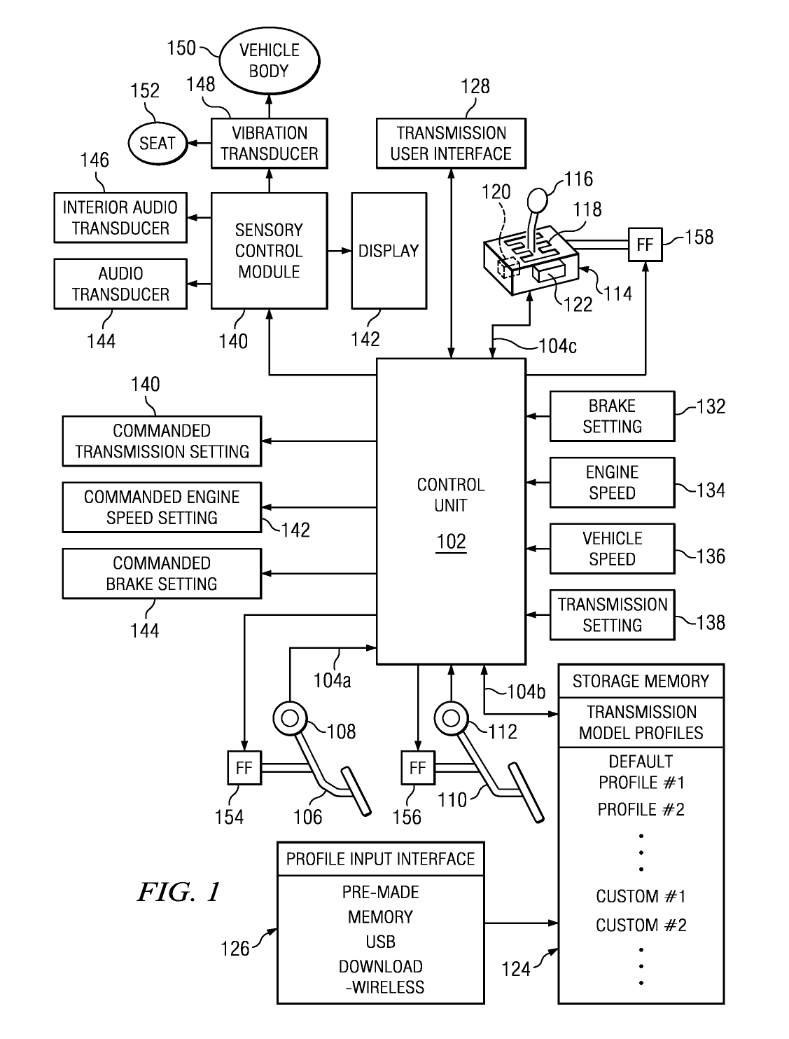

FIG. 1 illustrates an embodiment of a system 100 for simulating manual transmission operation in a vehicle having an automatic transmission. The system 100 includes a control unit 102 having a plurality of inputs 104a-104c for receiving one or more user input signals. In a particular embodiment, the control unit 102 includes at least one processor. In a particular embodiment, the control unit 102 may include a microprocessor. In another particular embodiment, the control unit 102 may include an application-specific integrated circuit (ASIC). The system 100 further includes a clutch pedal assembly 106 mounted below a dashboard of the vehicle. In a particular embodiment, as will be further described herein, the clutch pedal assembly 106 may be in an undeployed, or retracted, position when operating the vehicle in the automatic transmission mode, and a deployed position when operating the vehicle in the simulated manual transmission mode of operation. The clutch pedal assembly 106 further includes a clutch position sensor 108 in communication with the control unit 102 via the first input 104a. The clutch position sensor 108 is configured to measure a relative position of the clutch pedal such that the relative position varies when the clutch pedal is depressed by a user. Accordingly, the clutch pedal sensor 108 may provide position information that simulates a degree of engagement of a clutch pedal when operating a manual transmission. In various embodiments, the clutch pedal assembly 106 includes an electronic clutch pedal that is designed to mimic a standard mechanical clutch pedal feel and travel when operated by the user. In a particular embodiment, the clutch pedal sensor 108 of the clutch pedal assembly 106 includes one or more Hall effect sensors that determine the position, direction, and velocity of the clutch pedal actuation.

The system 100 further includes a throttle pedal assembly 110 mounted below the dashboard of the vehicle. The throttle pedal assembly 110 includes a throttle position sensor 112 configured to measure the relative position of the throttle pedal when such that the relative position varies when the throttle pedal is depressed by the user. The throttle position sensor 112 is in communication with the control unit 102 via the second input 104b. The system 100 further includes a gear selector assembly 114. The gear selector assembly 114 includes a gear selector 116 coupled to the gear selector assembly 114 configured to allow a user to shift the gear selector 116 into a number of gear positions. The gear selector assembly further includes a shift gate 118 configured to constrain movement of the gear selector 116 during shifting operations by the user to confine the gear selector 116 to movement to and from a number of discrete gear positions. The gear selector assembly 114 further includes a gear selector position sensor 120 in communication with the control unit 102 via the third input 104c. The gear selector position sensor 120 outputs a gear position user input signal indicative of a current position of the gear selector 116. The gear selector assembly 114 further includes a gate controller 122 that is configured to control whether a particular gate of the shift gate 118 is accessible by a user as will be further described herein. In a particular embodiment, the gear selector assembly 114 includes an electronic shifter that, while mechanical in physical hand actuation, incorporates one or more Hall effect sensors as part of the gear selector position sensor 120 that are used to detect the position and direction of motion associated with the driver's actual shifting motions of a shift lever as gear selection takes place.

The system 100 further includes a storage memory 124 in communication with the control unit 102. The storage memory 124 is configured to store one or more transmission model profiles therein. Each of the transmission model profiles includes a simulated manual transmission model for a particular manual transmission. The simulated manual transmission model is configured to receive user inputs representative of the operation of a manual transmission in a vehicle having an automatic transmission, simulate the behavior of a particular manual transmission when provided with these user inputs, and output control signals to the vehicle control systems that cause the vehicle to operate in a manner to mimic operation of a manual transmission.

In a particular embodiment, the storage memory 124 includes a default profile representing an automatic transmission mode of operation, one or more pre-configured profiles each representing a simulated manual transmission operation for a particular type of manual transmission and/or vehicle having a manual transmission, and one or more customizable profiles in which a user may customize the simulated manual transmission model to desired settings to replicate a desired manual transmission behavior. For example, the storage memory 124 may include a first pre-configured profile which is representative of a Ford Mustang having a manual transmission, a second pre-configured profile which is representative of a Pontiac GTO having a manual transmission, and a third pre-configured profile representative of a Ferrari having a manual transmission. In various embodiments, the storage memory 124 may include RAM, ROM, Flash memory or any other type of storage medium. The system 100 may further include a profile input interface 126 in communication with the storage memory 124 that is configured to allow one or more transmission model profiles to be loaded and stored within the storage memory 124. In various embodiments, the profile input interface 126 may allow loading of pre-made transmission model profiles from one or more of an external memory, a USB connection, or downloaded from a network using either a wired or wireless connection. In still other embodiments, the profile input interface 126 may allow interfacing with a handheld device, such as a mobile telephone, through either a wireless or wired connection to allow downloading of one or more transmission model profiles to the storage memory 134

The system 100 further includes a transmission user interface 128 in communication with the control unit 102. The transmission user interface 128 is configured to allow a user to select and configure various aspects of the simulated manual transmission operation including selection of a particular transmission model profile, enabling or disabling certain features, or controlling downloading of transmission model profiles into the storage memory 124 via the profile input interface 126.

The control unit 102 further includes system inputs 130a-130d configured to receive one or more vehicle system outputs indicative of the operation of various systems of the vehicle. In a particular embodiment, system input 130a is configured to receive a brake setting 132 indicative of brake status of the vehicle. For example, the brake setting 132 may indicate whether the brakes are currently being applied by the user or an automatic braking system as well as a degree of application of the brakes. System input 130b is configured to receive an engine speed 134 indicative of the current speed of the engine as measured in revolutions per minute (rpm) or another suitable unit of measurement. The system input 130c is configured to receive a vehicle speed 136 indicative of the current speed of the vehicle measured in miles per hour (mph) or another suitable unit of measurement. The system input 130d is configured to receive a transmission setting 138 indicative of the currently engaged gear of the automatic transmission of the vehicle. In various embodiments, the control unit 102 is configured to determine a simulated manual transmission response using a selected transmission model profile and at least one of the user input signals, and output one or more vehicle control signals corresponding to the simulated manual transmission response. In some embodiments, the control unit 102 may, in addition to the one or more user input signals, use one or more of the vehicle system inputs to determine the simulated manual transmission response. The vehicle control signals may then be used to control the vehicle systems in order to simulate the behavior of the selected transmission model profile. The outputted vehicle control signals may include one or more of a commanded transmission setting 140 indicative of a particular gear to which the automatic transmission should be shifted, a commanded engine speed setting 142 indicative of a particular engine speed to which the engine of the vehicle should be transitioned to, and a commanded brake setting 144 indicative of a brake setting to which the vehicle brakes should be applied.

For example, in a particular operation, if a user engages the clutch pedal assembly 106 in an incorrect manner for a particular simulated manual transmission model, the commanded brake setting 144 may indicate that the brakes of the vehicle should be applied to simulate jerkiness associated with improper application of the clutch pedal assembly 106. In another example of operation, if the clutch pedal assembly 106 is not applied in the proper manner for a particular simulated manual transmission model, the commanded engine speed setting 142 may indicate that the engine or motor of the vehicle may be reduced to a minimum setting to simulate stalling or may be modulated to simulated lugging of the vehicle.

The system 100 may further include a sensory control module 140 in communication with the control unit 102. The sensory control module 140 is configured to provide various sensory experiences to the user as indicated by the particular selected transmission model profile. The sensory control module 140 may be configured to provide audio, visual, and other sensory outputs to the user. In the particular illustrated embodiment, the system 100 includes a display 142 in communication with the sensory control module 140. The display 142 is configured to provide visual feedback to the user. In at least one embodiment, the display 142 provides an illustration of a particular shift pattern associated with the selected transmission model profile. In still other embodiments, the display 142 provides options to a user such as for the selection of a particular transmission model profile from a list of stored transmission model profiles and/or an indication of particular enabled or disabled features of the system 100. In various embodiments, the display 142 may include an LCD display, an LED display, or any other type of display device.

The system 100 further includes an exterior audio transducer 144 in communication with the sensory control module 140. The external audio transducer 144 provides an audio output to the exterior of the vehicle. The system 100 further includes an interior audio transducer 146 in communication with the sensory control module 140. The interior audio transducer 146 is configured to provide an audio output to the interior of the vehicle. In various embodiments, the exterior audio transducer 144 and the interior audio transducer 146 provide an audio output that simulates the sounds associated with operation of a particular vehicle having the selected transmission model profile. For example, the exterior audio transducer 144 and the interior audio transducer may output engines sounds such as acceleration and deceleration noises, sounds of a lugging engine, transmission noises such as grinding gears, wind noises, and other ambient sounds associated with a particular vehicle and manual transmission. In various embodiments, the transmission model profile includes one or more audio samples or files for output to one or more of the exterior audio transducer 144 and the interior audio transducer 146. In particular embodiments, the exterior audio transducer 144 and the interior audio transducer 146 may be comprised of one or more audio speakers. In various embodiments, the user may use the transmission user interface 128 to individually disable, enable, or control the volume of the exterior audio transducer 144 and the interior audio transducer 146. For example, the user may choose to only playback the sounds associated with a particular selected transmission model profile inside the vehicle interior.

The system 100 further includes a vibration transducer 148 in communication with the sensory control module 140. The vibration transducer 148 may be coupled to one or more of the vehicle body 150 and/or a vehicle seat 152. The vibration transducer 148 is configured to induce a vibration to the vehicle body 150 or the vehicle seat 152 to which it is coupled. In at least one embodiment, the vibration characteristics associated with a particular transmission model profile are stored within the transmission model profile. The amplitudes and frequencies of the vibrations experience by the user are determined from the transmission model profile such that the vibrations are representative of vibrations that would be experienced with a user operating the particular vehicle associated with the transmission model profile. Examples of vibrations that may be experienced by the user include vibrations associated with the engine or transmission of a vehicle. In one or more embodiments, the vibration transducer 148 is a mechanical transducer configured to impart a vibration to an object to which it is affixed. In various embodiments, the user may use the transmission user interface 128 to disable, enable, or control the amplitude of the vibrations of the vibration transducer 148.

In some embodiments, one or more of the user interfaces of the vehicle may be provided with force feedback mechanisms. In a particular embodiment, the clutch pedal assembly 106 is coupled to a first force feedback device 154 under control of the control unit 102. The throttle pedal assembly 110 is coupled to a second force feedback device 156 under control of the control unit 102, and the gear selector assembly 114 is coupled to a third force feedback device 158 under control of the control unit 102. In such embodiments, the first force feedback device 154, the second force feedback device 156 and the third force feedback device 158 provide force feedback to the user via the clutch pedal assembly 106, the throttle pedal assembly 110 and the gear selector assembly 114, respectively, during operation of the vehicle in the selected transmission model profile. In such embodiments, the characteristics of the force feedback may be included within the transmission model profile.

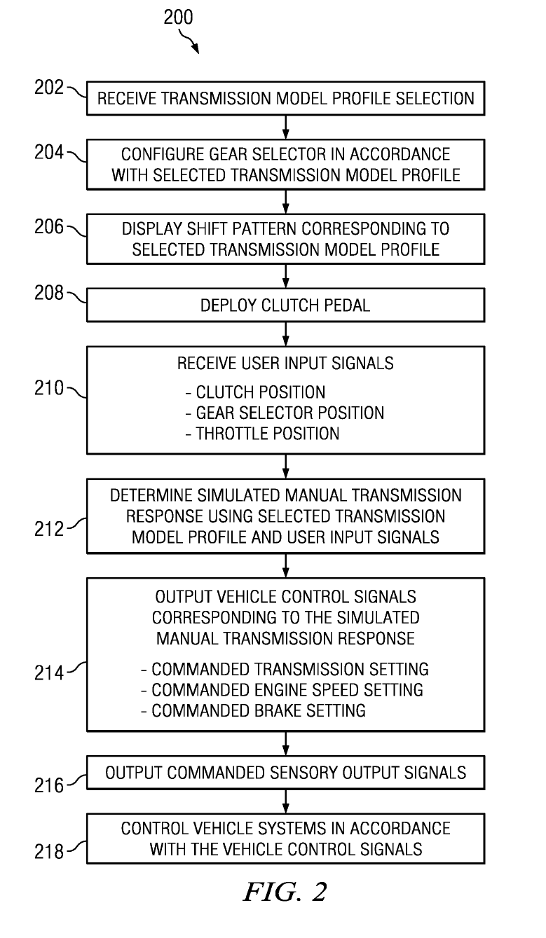

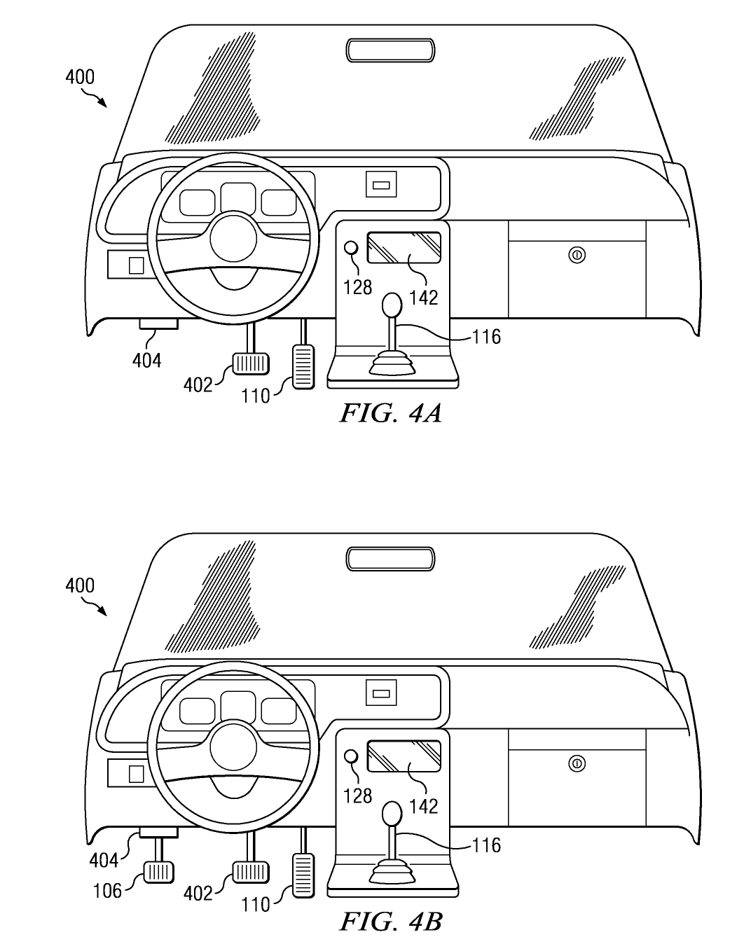

FIG. 2 illustrates an embodiment of a process 200 for simulating manual transmission operation in a vehicle having an automatic transmission. In step 202, a transmission model profile selection is received from a user. In various embodiments, the user may be presented with a list of available transmission model profiles stored within the storage memory 124, and the user may select a particular transmission model profile from the list. In step 204, the gear selector assembly 114 is configured in accordance with the selected transmission model profile. In a particular embodiment, the gate controller 122 closes gates of the shift gate 118 that are not to be used for the particular selected transmission model profile to provide a shift pattern associated with the particular selected transmission model profile, as will be further described herein. In step 206, the shift pattern corresponding to the selected transmission model profile is displayed within the display 142. For example, the displayed shift pattern may include an indication of the gear positions of the reverse, first, second, third, fourth, etc. gears corresponding to the selected transmission model profile associated with the particular simulated manual transmission. In some embodiments, the displayed shift pattern may include an indication of the currently selected gear. In step 208, the clutch pedal assembly is deployed from a retracted position to a deployed position so that it may be operated by the user as will be further described with respect to FIGS. 4A-4B. In step 210, user input signals are received from a user using one or more user input controls of the vehicle. For example, in a particular embodiment, the user input signals may be indicative of a clutch position of the clutch pedal assembly 106, a gear selector position of the gear selector assembly 114, and a throttle position of the throttle pedal assembly 110.

In step 212, a simulated manual transmission response is determined using the selected transmission model profile and the user input signals. In some embodiments, vehicle system outputs such as the brake setting 132, engine setting 134, vehicle speed 136 and transmission setting 138 may also be used in calculation of the simulated manual transmission response. In step 214, vehicle control signals corresponding to the simulated manual transmission response are outputted. In some embodiments, the vehicle control signals may include a commanded transmission setting 140, a commanded engine speed setting 142, and a commanded brake setting 144. The output vehicle control signals command the vehicle control systems to behave in such a way as to simulate operation of a manual transmission in accordance with the selected transmission model profile.

In at least one embodiment, the selected transmission model profile many include a plurality of lookup tables that map a particular user input parameter to a particular output parameter to be used in calculating the simulated manual transmission response. In a particular embodiment, the selected transmission model profile may include lookup tables corresponding to the simulated manual transmission and/or vehicle that map clutch pedal position vs. percentage of engine torque output, gear selector position vs. simulated gear ratio, and throttle position vs. simulated torque percentage and/or simulated horsepower. The selected transmission model profile may further include a simulated final drive ratio value, such as a rear end gear ratio, corresponding to the final drive ratio of the simulated manual transmission. Based up a received throttle position, clutch position, current gear selection, the lookup tables may be used to determine a commanded throttle setting and a commanded transmission gear setting to produce an output torque at the wheels of the vehicle using the actual engine of the vehicle corresponding to the manual transmission characteristics of the simulated manual transmission and/or vehicle.

In step 216, commanded sensory output signals are output to the sensory control module 140. In response to the commanded sensory output signals, various audio, visual and vibration outputs are presented to the user. For example, a particular interior audio signal, exterior audio signal or vibration signal may be imparted to the user to correspond to audio and vibration characteristics associated with the selected transmission model profile. In step 218, the vehicle control systems are controlled in accordance with the outputted vehicle control signals. In some embodiments, the user may use the transmission user interface 128 to enable or disable various aspects of the simulated manual transmission operation such as disabling one or more of the interior audio transducer 146, the exterior audio transducer 144, or the vibration transducer 148.

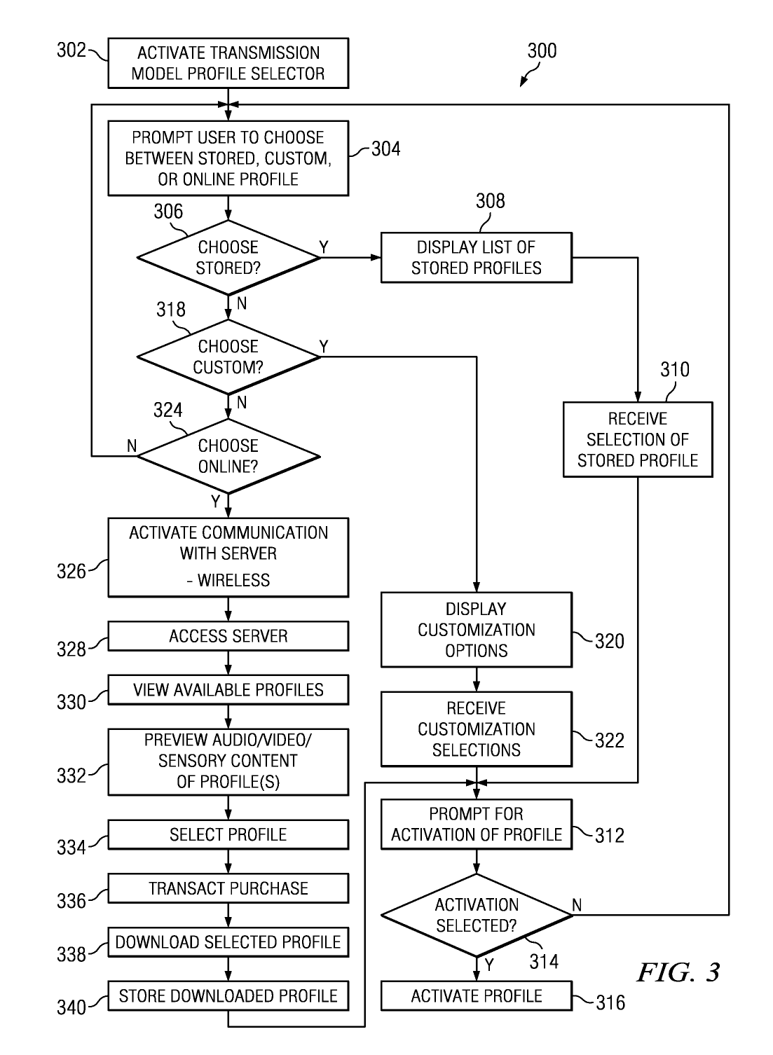

FIG. 3 illustrates an embodiment of a procedure 300 for purchase and activation of a transmission model profile. In step 302, a transmission model profile selector is activated by the user using the transmission user interface 128. In step 304, the user is prompted via display 142 to choose between a stored profile, a custom profile or an online profile available for purchase. In step 306, it is determined whether the user chose a stored profile. If the user chose a stored profile, a list of stored profiles is displayed to the user in step 308. In step 310, a selection of a stored profile from the displayed list is received from the user. In step 312, the user is prompted regarding whether the user wishes to activate the selected profile. In step 314, if it is determined that the user wishes to activate the selected profile, the profile is activated in step 316. If it is determined in step 314 that the user does not wish to activate the selected profile, the procedure returns to step 304 in which the user is prompted to choose between stored, custom or online profiles. If it is determined in step 306, that the user does not wish to choose a stored profile, the procedure continues to step 318 in which it is determined whether the user chose a custom profile. If the user chose a custom profile, a variety of customization options are displayed to the user in step 320. In step 322, customization selections associated with the custom profile are received from the user. The customization selections may include setting gear ratios for one or more gears, setting a final gear ratio, selecting the number of gears, and selecting a shift pattern for the simulated manual transmission. The customization selections may further include associating one or more sound files with various aspects of the operation of the simulated manual transmission, and setting vibration characteristics of the simulated manual transmission. The procedure 300 then proceeds to step 312 as previously described.

If it is determined in step 318 that the user did not choose a custom profile, the procedure 300 continues to step 324 in which it is determined whether the user chose an online profile. If the user did not choose an online profile, the procedure 300 returns to step 304. If the user chose to purchase an online profile, the procedure continues to step 326 in which communication with a server is activated. In a particular embodiment, communication with the server may include a wireless communication over either a user's mobile telephone, or a wireless communication system associated with the vehicle. In step 328, the server is accessed and a list of available transmission model profiles is downloaded to the vehicle. In step 330, the user may view the list of available transmission model profiles. In step 332, the user may preview audio, video and/or sensory content associated with a particular available transmission model profile to determine whether the user wishes to purchase the particular transmission model profile. In some embodiments, the user may preview one or more performance characteristics associated with the particular transmission model profile.

In step 334, the user selects the particular transmission model profile that the user desires to purchase. At step 336, the purchase of the selected transmission model profile is transacted. In particular embodiments, the user may be prompted to enter a credit card or other account number in order to transact the purchase. In still other embodiments, the user may have an already existing account to purchase transmission model profiles. In step 338, the selected transmission model profile is downloaded, and in step 340 the selected transmission model profile is stored within the storage memory 124. The procedure then continues to step 312 in which the user is prompted for activation of the profile as described above.

FIG. 4A illustrates an embodiment of a dashboard configuration 400 of a vehicle in which the clutch pedal assembly 106 is in a retracted position. In the particular embodiment illustrated in FIG. 4A, the display 142, the transmission user interface 128 and the gear selector 116 are disposed on the dashboard of the vehicle. The throttle pedal assembly 110 and a brake assembly 402 are disposes below the dashboard, and a clutch pedal deployment mechanism 404 is disposed substantially behind the dashboard. The clutch pedal deployment mechanism 404 is configured to retract and deploy the clutch assembly 106 in accordance with whether a transmission model profile associated with a simulated manual transmission operation is currently active. In the particular embodiment illustrated in FIG. 4A, the vehicle is configured in the automatic transmission mode, and the clutch pedal deployment mechanism 404 has retracted the clutch pedal assembly 106 into a retracted mode such that it is not operable by the user. FIG. 4B illustrates an embodiment of the dashboard configuration 400 in which the clutch pedal deployment mechanism 404 has extended the clutch pedal assembly 106 into the deployed position. In the embodiment illustrated in FIG. 4B, a transmission model profile has been selected to operate the vehicle in a simulated manual transmission mode. In the deployed position, the clutch pedal assembly 106 is operable by the user for use with the simulated transmission model. Although the embodiment of FIGS. 4A-4B illustrate use of a clutch pedal deployment mechanism 404 that retracts the clutch pedal assembly 106 into an upper position, it should be understood that other types of clutch pedal deployment mechanism may be used in other embodiments. For example, the clutch pedal assembly 106 may be retracted flush against a floorboard of the vehicle when the vehicle is not operating in the simulated manual transmission mode. In still another embodiment, the clutch pedal assembly 106 may be retracted within a compartment when the vehicle is not operating in the simulated manual transmission mode.

Referring now to FIGS. 4C and 4D, in still other embodiments, the gear selector assembly 114 may be in a retracted position when the vehicle is operated in the automatic transmission mode, and into a deployed position when the vehicle is operated in the simulated manual transmission mode. FIG. 4C illustrates an embodiment, similar to that of FIGS. 4A and 4B, wherein the gear shift portion of the dashboard 400 (FIGS. 4A-4B) has a gear shifter 116 that is in a retracted position and covered by doors. FIG. 4D illustrates the gear shift portion of the dashboard 400 in which the gear shifter 116 is in a deployed position. In the deployed position, the doors are opened and the gear shift 116 is extended upward. In a particular embodiment, the gear selector assembly 114 may be retracted into the floorboard, behind the dashboard, or within the dashboard when the vehicle is not operating in the simulated manual transmission mode. In a particular embodiment, the gear selector assembly 114 may be configured such that when the vehicle is place in the simulated manual transmission mode, an automatic transmission gear selector is moved in a folded down position in which it is hidden within the dashboard. In addition, the gear selector assembly 114 is moved from a folded down position within the dashboard in which it is not visible to a deployed position for use in the simulated manual transmission mode.

In various embodiments, the driver may activate the simulated manual transmission mode which causes a number of automatic actions to occur to cause the gear selector assembly 114 to present itself in a center console in a position where a driver expects a manual transmission shift lever to be placed, and a clutch pedal assembly 106 to be positioned into place directly to the left of the brake pedal in a position where the driver would expect to find the clutch pedal if he or she were driving a vehicle equipped with a manual transmission.

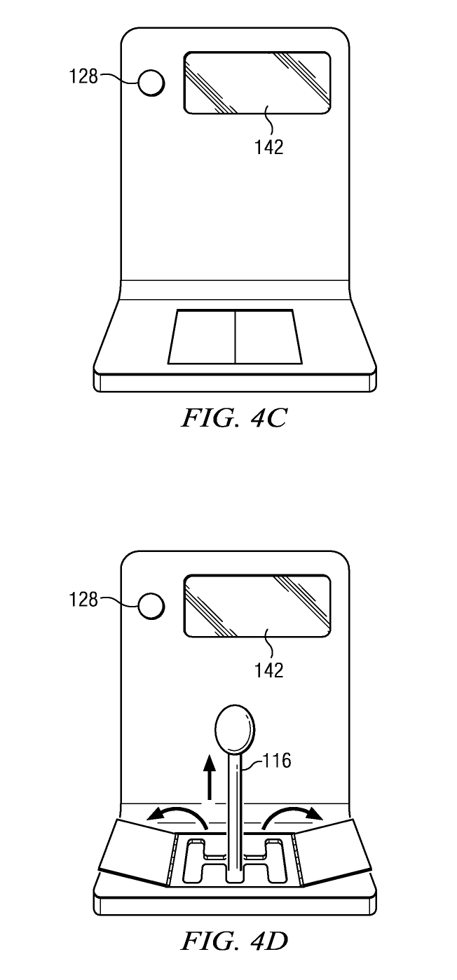

FIGS. 5A-5C illustrate embodiments of a shift gate 118 of the gear selector assembly 114. In the particular embodiments illustrated in FIGS. 5A-5C, the shift gate 118 includes six gates, each of which may be individually locked out by the gate controller 122 in accordance with a particular selected transmission model profile. Although the embodiments illustrated in FIGS. 5A-5C are shown with no shift boot, it should be understood that in some embodiments a shift boot may be included to cover the shift gate 118. FIG. 5A illustrates an embodiment of a shift gate 118 of the gear selector assembly 114 in an automatic transmission mode of operation. In the embodiment illustrated in FIG. 5A, a first blocking gate 502a have been moved into a position to block out the third, fourth, fifth, and sixth gates of the shift gate 118 under control of the gate controller 122 to produce a gate pattern for automatic transmission operation. In the particular embodiment illustrated in FIG. 5A, the gear selector may be moved into four possible positions: a park position (P), a reverse position (R), a neutral position (N), and a driver position (D) in accordance with typical operation of an automatic transmission.

FIG. 5B illustrates an embodiment of the shift gate 118 in which the gate controller 122 has configured the shift gate 118 for a four gate position configuration. In the embodiment illustrated in FIG. 5B, a second blocking plate 502b has been moved into a position to block out the fifth and sixth gates of the shift gate 118 under control of the gate controller 122 to produce an equivalent gate pattern 504 having four gear positions. For example, the shift gate 118 in the configuration illustrated in FIG. 5B may be used to provide for shifting into one of a reverse gear, a first gear, second gear, and third gear. In various embodiments, a position located between the gear positions may be used to provide a neutral gear position. FIG. 5C illustrates an embodiment of the shift gate 118 in which the first shift gate is blocked by a blocking plate 502c under control of the gate controller 122 to produce an equivalent shift pattern 506 having five gear positions. Although the particular embodiments illustrated in FIGS. 5A-5C are illustrated as using a shift gate 118 having six possible gate positions, it should be understood that in other embodiments, the shift gate 118 may include any number of possible shift gate positions. For example, in a particular embodiment, the shift gate 118 may be provided with eight possible shift gate positions for transmissions having up to eight possible gear positions.

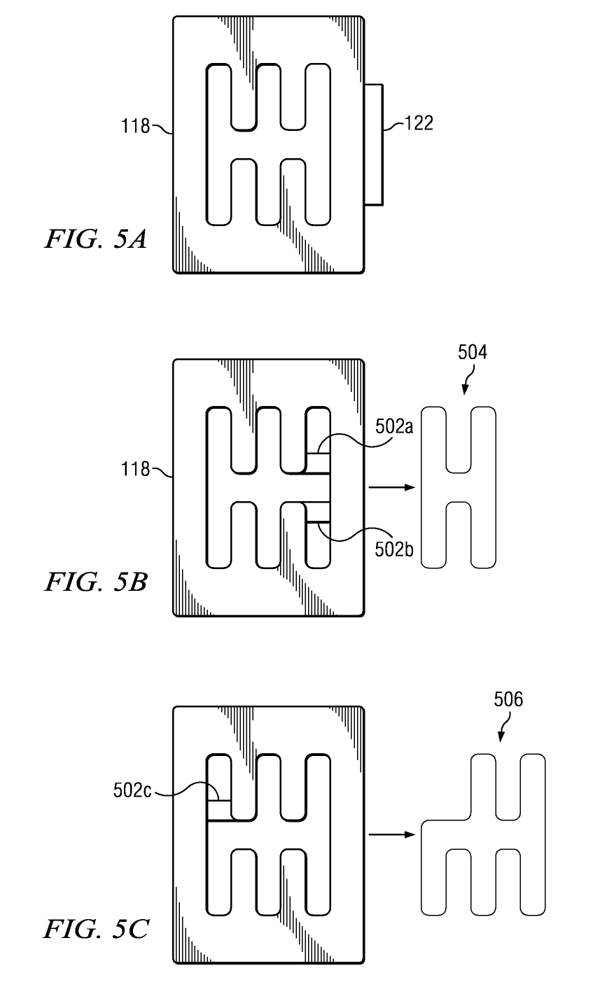

FIG. 6A illustrates an embodiment of a shift pattern 600 configured for display on the display 142 in accordance with a particular selected transmission model profile. In the embodiment illustrated in FIG. 6A, the shift gate 118 has been configured for a four-position shift pattern in which the upper left gate is configured for reverse operation, the left lower gate is configured for first gear, the upper right gate is configured for second gear, and the lower right position is configured for third gear. FIG. 6B illustrates another embodiment of a shift pattern 602 for display on the display 142 in accordance with a selected transmission model profile in which the shift gate 118 is configured for five gear positions. In the embodiment illustrated in FIG. 6B, the left lower gate is configured for reverse operation, the middle lower gate is configured for first gear, the upper middle gate is configured for second gear, the lower right gate is configured for third gear and the upper right gate is configured for fourth gear. FIG. 6C illustrates an embodiment of a shift pattern 604 for display using the display 142 in which the shift gate 118 is configured for seven gear positions. In a particular embodiment illustrated in FIG. 6C, the left-most lower gate is configured for reverse operation, the second upper gate is configured for first gear, the second lower gate is configured for second gear, the third upper gate is configured for third gear, the third lower gate is configured for fourth gear, the right-most upper gate is configured for fifth gear, and the right-most lower gate is configured for sixth gear. In various embodiments, the display 142 may be further provided with an indication of the currently selected gear within the shift pattern displayed on the display device 142. In still other embodiments, the display 142 may be further provided with an indication of a neutral gear position within the shift pattern displayed on the display device 142.

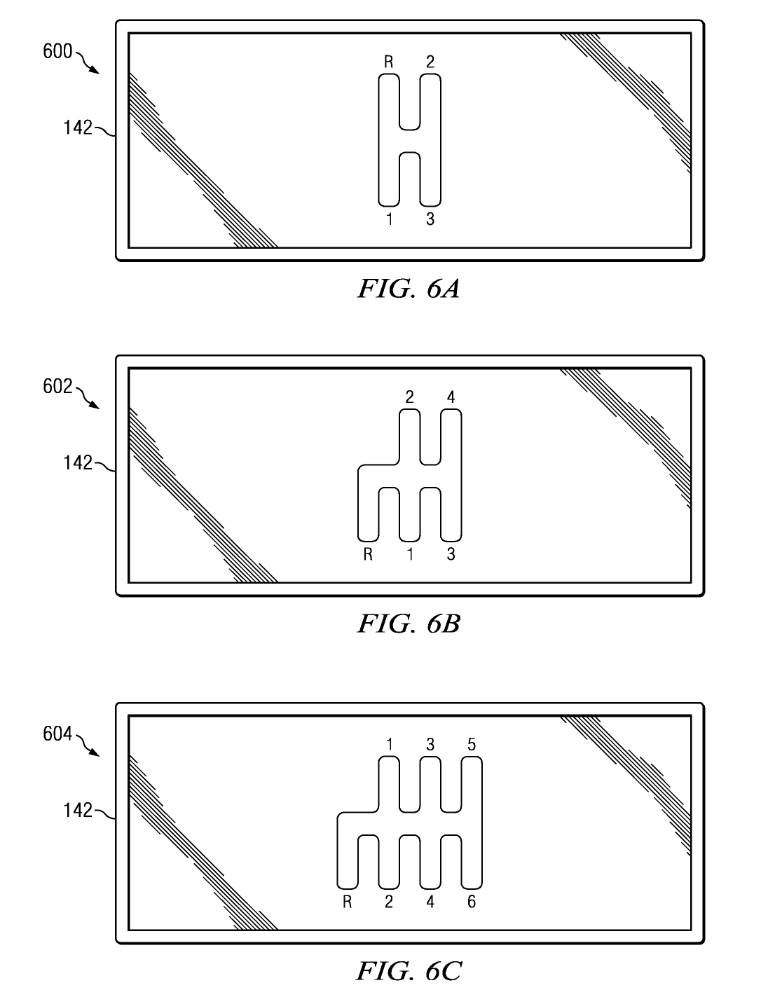

FIGS. 7A and 7B illustrate embodiments of throttle position vs. supplied engine torque curves for use in calculating a simulated manual transmission response. FIG. 7A illustrates an embodiment of a throttle position vs. supplied engine torque curve 700 for use in calculating a simulated transmission model response. In the embodiment of FIG. 7A, the throttle position axis is representative of the throttle position applied by the user in which 0% represents no throttle being applied and 100% represents full throttle being applied. The Tₜᵣₐₙₛ axis represents the percentage of available engine torque from the actual engine of the vehicle that is to be supplied by the engine of the vehicle in which 0% represents that no torque should be supplied by the engine and 100% representing that all available torque should be supplied from the engine. The throttle position vs. supplied engine torque curve 700 illustrated in FIG. 7A has a linear response to correspond to the throttle response of a simulated vehicle having a linear throttle response. FIG. 7B illustrates another embodiment of a throttle position vs. supplied engine torque curve 702 for use in calculating a simulated manual transmission model response. The throttle position vs. supplied engine torque curve 702 illustrated in FIG. 7B has a non-linear response to correspond to the throttle response of a simulated vehicle having a non-linear throttle response. In various embodiments, throttle position and T_{Trans} values corresponding to selected points along the curves 700 and 702 may be stored in one or more lookup tables.

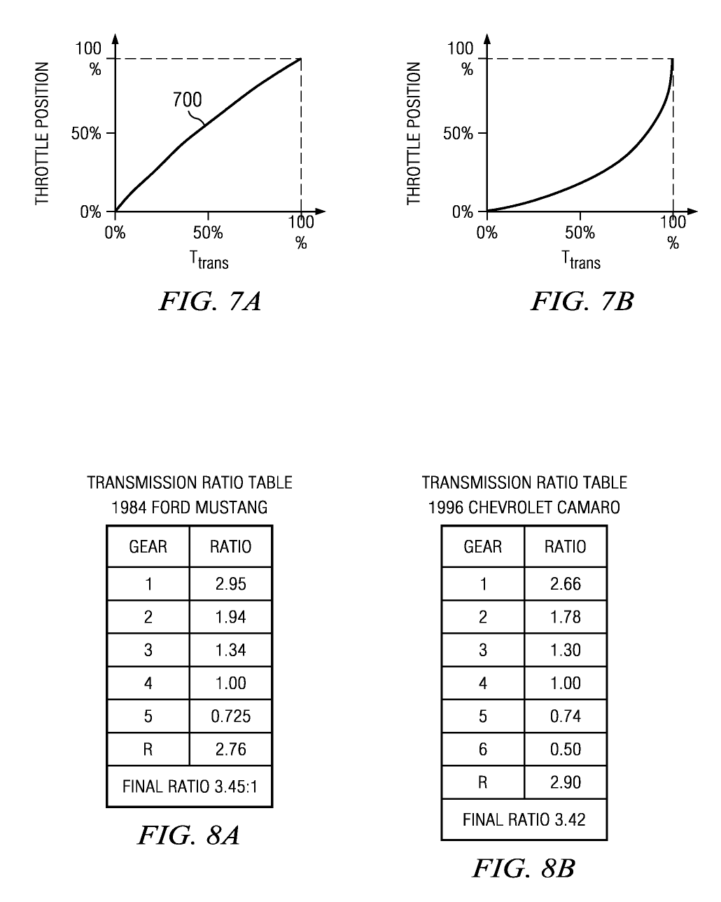

FIGS. 8A and 8B illustrate embodiments of gear selector position vs. simulated gear ratio lookup tables for use in calculating a simulated manual transmission response. FIG. 8A illustrates an embodiment of a gear selector position vs. simulated gear ratio lookup table for a 1984 Ford Mustang having a five-speed manual transmission. FIG. 8B illustrates an embodiment of a gear selector position vs. simulated gear ratio lookup table for a 1996 Chevrolet Camaro having a six-speed manual transmission. In response to receiving a selected gear position, the gear selector position vs. simulated gear ratio lookup table corresponding to a selected transmission model profile may be used calculate a commanded transmission setting and commanded torque output value to produce a simulated manual transmission response.

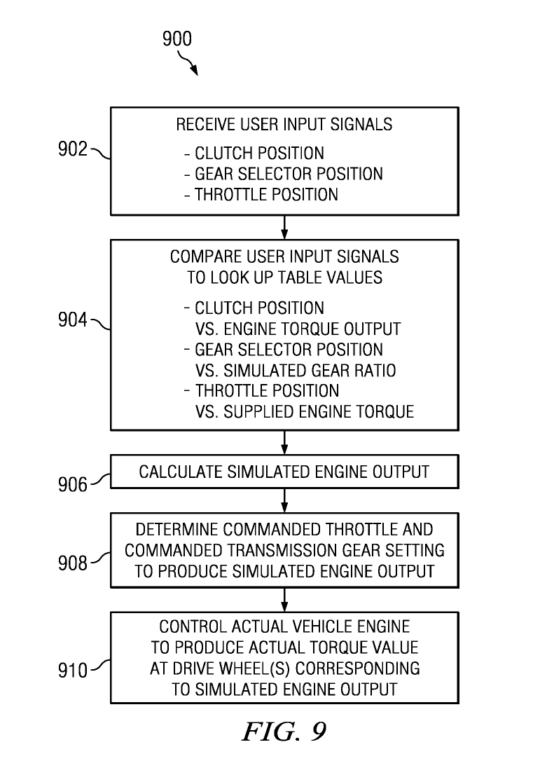

FIG. 9 illustrates an embodiment of a process 900 for determining a simulated manual transmission response using a selected transmission model profile and user input signals. In step 902, user input signals are received from a user using one or more user input controls of the vehicle. In the particular embodiment illustrated in FIG. 9, the user input signals are indicative of a clutch position of the clutch pedal assembly 106, a gear selector position of the gear selector assembly 114, and a throttle position of the throttle pedal assembly 110. In step 904, the user input signals are compared to values found in a plurality of lookup tables associated with a selected transmission model profile corresponding to a particular simulated manual transmission and/or vehicle. In the particular embodiment illustrated in FIG. 9, the lookup tables include a clutch position vs. engine torque output lookup table, a gear selector position vs. simulated gear ratio lookup table having an associated final gear ratio, and a throttle position vs. supplied engine torque table. In step 906, a simulated engine output is calculated from the lookup tables that is based on the clutch position, throttle position, and gear position as if it was a real clutch, real transmission, and real engine of the manual transmission and powerplant corresponding to the selected transmission model profile. In step 908, a commanded throttle value and commanded transmission gear setting is determined to produce the simulated engine output from the actual vehicle engine. In step 910, the actual vehicle engine is controlled to produce an actual torque value at the drive wheel(s) of the vehicle corresponding to the simulated engine output. In various embodiments, further control signals may be generated to modulate the vehicle brakes to simulate effects such as vehicle shudder due to improper operation of the clutch. Further control signals may be generated to produce environmental effects, such as sound and vibration, associated with the selected transmission model profile.

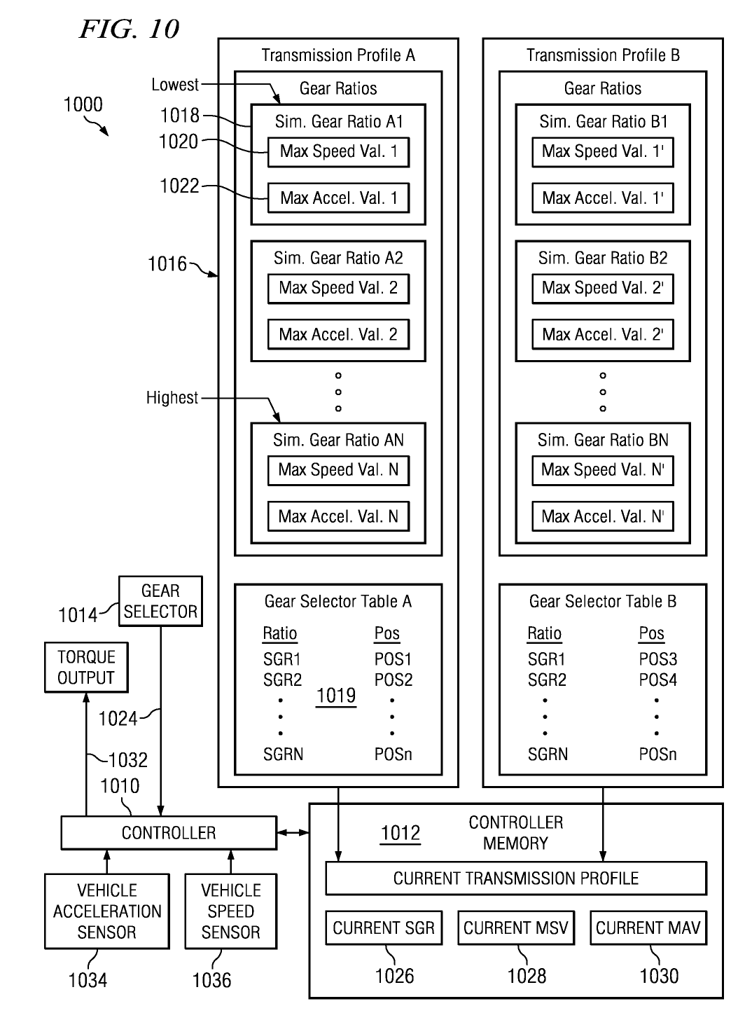

Referring now to FIG. 10, there is illustrated another system and method for simulating a manual transmission. The system 1000 controls the acceleration and speed of a vehicle so as to produce user sensations simulating the experience of a vehicle having a user-selectable one of a plurality of manually-controlled transmissions. The system 1000 includes a controller 1010 having an electronic memory 1012 and a gear selector 1014 movable between a plurality of unique positions. A plurality of different transmission profiles 1016 may be loaded into the electronic memory 1012 of the controller 1010. Each transmission profile 1016 includes a plurality of simulated gear ratios (“SGR”) 1018 ranging from a lowest simulated gear ratio to a highest simulated gear ratio and a gear selector table 1019 correlating each of the plurality of simulated gear ratios with a unique position of the gear selector 1014. Each of the simulated gear ratios 1018 includes a maximum speed value 1020 and a maximum acceleration value 1022. The lowest simulated gear ratio 1018 has a lowest maximum speed value 1020, and the corresponding maximum speed value for each simulated gear ratio increases for successively higher simulated gear ratios. The lowest simulated gear ratio 1018 has a highest maximum acceleration value 1022, and the corresponding maximum acceleration value for each simulated gear ratio decreases for successively higher simulated gear ratios. The gear selector 1014 provides a gear selector position signal (denoted by arrow 1024) to the controller 1010 that is indicative of a current position of the gear selector selected from the unique positions. Using the gear selector position signal 1024 and the gear selector table 1019, the controller 1010 determines a current simulated gear ratio 1026 corresponding to the current position of the gear selector 1014. Using the current simulated gear ratio 1026, the controller 1010 determines a current maximum speed value 1028 and a current maximum acceleration value 1030 corresponding to the current simulated gear ratio. The controller 1010 controls the torque output (denoted by arrow 1032) between a motor and a drive wheel of the vehicle to limit the acceleration of the vehicle (measured by acceleration sensor 1034) to the current maximum acceleration value 1030 and to limit the speed of the vehicle (measured by the speed sensor 1036) to the current maximum speed value 1028.

Although the preferred embodiment has been described in detail, it should be understood that various changes, substitutions and alterations can be made therein without departing from the spirit and scope of the invention as defined by the appended claims.

What is claimed is:

1. A method for controlling the acceleration and speed of a vehicle so as to produce user sensations simulating the experience of a vehicle having a user-selectable one of a plurality of manually-controlled transmissions, the method comprising the following steps:
providing a system including a controller having an electronic memory and a gear selector movable between a plurality of unique positions;
loading one of a plurality of different transmission profiles into the electronic memory of the controller, each transmission profile including
a plurality of simulated gear ratios ranging from a lowest simulated gear ratio to a highest simulated gear ratio;
a gear selector table correlating each of the plurality of simulated gear ratios with a unique position of the gear selector;
each of the simulated gear ratios including a maximum speed value and a maximum acceleration value;
wherein the lowest simulated gear ratio has a lowest maximum speed value, and the corresponding maximum speed value for each simulated gear ratio increases for successively higher simulated gear ratios;
wherein the lowest simulated gear ratio has a highest maximum acceleration value, and the corresponding maximum acceleration value for each simulated gear ratio decreases for successively higher simulated gear ratios;
providing a gear selector position signal to the controller that is indicative of a current position of the gear selector selected from the unique positions;
using the gear selector position signal received by the controller and the gear selector table to determine a current simulated gear ratio corresponding to the current position of the gear selector;
using the current simulated gear ratio to determine a current maximum speed value and a current maximum acceleration value corresponding to the current simulated gear ratio;
controlling, by the controller, the torque output between a motor and a drive wheel of the vehicle to limit the acceleration of the vehicle to the current maximum acceleration value; and
controlling, by the controller, the torque output between the motor and the drive wheel of the vehicle to limit the speed of the vehicle to the current maximum speed value.

2. The method of claim 1, further comprising the steps of:
providing a clutch pedal movable through a first range of motion, wherein each transmission profile further includes a clutch profile, the clutch profile defining a relation between a simulated clutch pedal position and a torque output modifier, the torque output modifier representative of a percentage to which the torque output between the motor and the drive wheel is changed in relation to the simulated clutch pedal position;
providing a clutch position signal to the controller that is indicative of a current position of the clutch pedal within the first range of motion;
using the current position of the clutch pedal assembly to determine a current torque output modifier; and
modifying, by the controller, the torque output between the motor and the drive wheel of the vehicle in accordance with the current torque output modifier.

3. The method of claim 1, further comprising the steps of:
providing a throttle pedal movable through a second range of motion;
providing a throttle pedal position signal to the controller that is indicative of a current position of the throttle pedal within the second range of motion; and
modifying, by the controller, the torque output between the motor and the drive wheel in accordance with the current position of the throttle pedal.

4. The method of claim 1, further comprising the step of receiving a selection of the one of the plurality of different transmission profiles.

5. The method of claim 4, further comprising the step of configuring the gear selector in accordance with the selected transmission profile.

6. The method of claim 4, further comprising the step of deploying the gear selector in response to the selection of the transmission profile.

7. The method of claim 4, further comprising the step of deploying a clutch pedal in response to the selection of the transmission profile.

8. The method of claim 4, further comprising the steps of:
providing a sensory control module; and
outputting at least one commanded sensory output signal from the sensory control module in accordance with the selected transmission profile.

9. The method of claim 8, wherein the at least one commanded sensory output signal includes at least one of an exterior audio signal, interior audio signal, and a vibration signal.

10. The method of claim 4, further comprising the step of displaying a shift pattern corresponding to the selected transmission profile.

11. The method of claim 1, wherein the vehicle is a hybrid vehicle having a partially internal combustion and partially electric drive system.

12. The method of claim 1, wherein the vehicle has an electric drive system.

13. The method of claim 1, wherein the vehicle has an internal combustion motor with an automatic transmission.

14. A reconfigurable transmission control system for a vehicle configured to produce user sensations simulating the experience of a vehicle having a user-selectable one of a plurality of manually-controlled transmissions comprising:
at least one memory, the at least one memory configured to store at least one of a plurality of different transmission profiles;
a controller in communication with the at least one memory; and
a transmission control interface in communication with the controller, the transmission control interface adapted to be configured in accordance with a selected one of the plurality of different transmission profiles.

15. The reconfigurable transmission control system of claim 14, wherein the transmission control interface is a gear selector having a gate shift pattern that is reconfigurable in accordance with the selected one of the plurality of different transmission profiles.

16. The reconfigurable transmission control system of claim 14, wherein the transmission control interface is a clutch pedal that is reconfigurable in accordance with the selected one of the plurality of different transmission profiles.

17. The reconfigurable transmission control system of claim 14, further including a force feedback device coupled to the transmission control interface, the force feedback device configured to provide force feedback to the transmission control interface in accordance with the selected one of the plurality of different transmission profiles.

18. The reconfigurable transmission control system of claim 14, wherein the transmission control interface is retractable such that it moves between a retracted configuration which is not accessible by a user and a deployed configuration that is accessible by a user.

19. The reconfigurable transmission control system of claim 14 further comprising:
a display configured to display a shift pattern corresponding to the selected one of the plurality of different transmission profiles.

20. The reconfigurable transmission control system of claim 14 further comprising:
a sensory control module configured to output at least one commanded sensory output signal in accordance with the selected transmission model profile.

21. The reconfigurable transmission control system of claim 20, wherein the at least one commanded sensory output signal includes at least one of an exterior audio signal, interior audio signal, and a vibration signal.
